(19) United States
(12) Patent Application Publication
(10) Pub. No.: US 2022/0408759 A1
(43) Pub. Date: Dec. 29, 2022

(54) METHOD FOR THE PRODUCTION OF A BEVERAGE FOR HUMAN CONSUMPTION, WHICH IS FILLED INTO A CONTAINER AND WHICH CONTAINS AT LEAST ONE EMPIRICAL PIECE OF AT LEAST ONE FLAVOR CARRIER

(71) Applicant: Die Frischemanufaktur GmbH, Merseburg OT Beuna (DE)

(72) Inventors: Jenny MUELLER, Muenchen (DE); Daniel KOCH, Leuna (DE)

(73) Assignee: Die Frischemanufaktur GmbH, Merseburg OT Beuna (DE)

(21) Appl. No.: 17/780,183

(22) PCT Filed: May 9, 2021
(86) PCT No.: PCT/EP2021/000063

§ 371 Date: May 26, 2022

(30) Foreign Application Priority Data
May 23, 2020 (DE) 10 2020 003 111.0

(51) Int. Cl. A23L 2/56; A23L 2/68; A23L 2/44; A23L 33/16; A23L 33/21; A23L 2/02

(52) U.S. Cl. CPC A23L 2/56; A23L 2/68; A23L 2/44; A23L 33/16; A23L 33/21; A23L 2/02

(57) ABSTRACT

In a method for producing a beverage for human consumption which is filled into a container and which contains at least one portion of at least one flavor carrier containing an organic material and/or a material of organic origins, the flavor carrier portion is dipped in a dip solution containing water, ascorbic acid, a first group, and, if provided, a second group, namely 74% to 98% of water, 0.5% to 5% of ascorbic acid, 0.5 to 2% of the first group, and 0% to 19% of the second group, for at least 15 seconds, then combined with a liquid containing water, ascorbic acid, and, if provided, the aforementioned second group, namely 70% to 98% of water, 2% to 5% of ascorbic acid, and 0% to 25% of the second group, in the container, and the storage life of the composition is influenced thermally or by use of high-pressure pasteurization.

Method for the production of a beverage for human consumption, which is filled into a container and which contains at least one empirical piece of at least one flavor carrier

The invention relates to a method for the production of a beverage for human consumption, which is filled into a container, wherein the beverage, speaking very generally, is a type of tea beverage in a certain manner, and specifically is included in the class of what are called “Infused Waters.” What are called “Infused Waters” are beverages filled into containers, generally non-alcoholic, in the case of which aside from the liquid as such, an empirical piece of a flavor carrier or multiple empirical pieces of a flavor carrier or multiple flavor carriers, such as, for example, a piece of lemon and/or a piece of pineapple and/or a sage leaf, is or are situated in the corresponding container. In this regard, the container according to the state of the art is regularly structured in the form of a bottle or at least similar to a bottle.

At this point it is explicitly stated that the special English beverage designation “Infused Waters” is used throughout also in the German-speaking countries, both by beverage specialists and the groups of customers interested in such beverages.

At this point, it is furthermore explicitly clarified that the terms “empirical piece” and “empirical flavor carrier piece” within the scope of the present specification and claims means, in each instance, a piece of an object that has a length, in at least one of its expanses, of at least 3 mm, preferably at least 5 mm, even more preferably at least 10 mm, further preferably at least 15 mm, even further preferably at least 20 mm, and even more preferably at least 30 mm.

Such “Infused Waters” known from the state of the art have a storage life of only approximately five days even in the refrigerated state. Afterwards they are no longer suitable for human consumption, or at best only conditionally suitable, i.e. with the acceptance of greatly deteriorated taste and appearance and/or the risk of causing diarrhea.

The invention is based on the task of making available a novel method for the production of a beverage for human consumption, which belongs to the class of “Infused Waters,” wherein the beverage produced using this novel method has a minimum storage life, both refrigerated and unrefrigerated, of twelve weeks, if possible, but of at least two weeks, while extensively maintaining the taste and consistency of the empirical flavor carrier piece or flavor carrier pieces contained in it.

According to the invention, this task is accomplished by means of a method according to claim 1. According to the invention, this task is also accomplished by means of a method according to claim 2. According to the invention, this task is also accomplished by means of a method according to claim 3. According to the invention, this task is furthermore accomplished by means of a method according to claim 4. According to the invention, this task is besides accomplished by means of a method according to claim 5. According to the invention, this task is furthermore also accomplished by means of a method according to claim 6.

Advantageous and preferred further developments of the method according to the invention in accordance with claim 1 are the object of claims 7 to 26 and 28 to 31. Advantageous and preferred further developments of the method according to the invention in accordance with claim 2 are the object of claims 7 to 26 and 28 to 31. Advantageous and preferred further developments of the method according to the invention in accordance with claim 3 are the object of claims 7 to 26 and 28 to 31. Advantageous and preferred further developments of the method according to the invention in accordance with claim 4 are the object of claims 7 to 26 and 28 to 31. Advantageous and preferred further developments of the method according to the invention in accordance with claim 5 are the object of claims 7 to 27 and 29 to 31. Advantageous and preferred further developments of the method according to the invention in accordance with claim 6 are the object of claims 7 to 27 and 29 to 31.

The invention is furthermore based on the task of making available a dip bath solution for use as the dip bath solution in one of the methods according to the invention named above.

According to the invention, this task is accomplished by means of a dip bath solution according to claim 32.

Advantageous and preferred embodiments of the dip bath solution according to the invention are the object of claims 33 and 34.

Furthermore, the invention is based on the task of making available a liquid for use as the liquid in one of the methods according to the invention named above.

According to the invention, this task is accomplished by means of a liquid according to claim 35.

Advantageous and preferred embodiments of the liquid according to the invention are the object of claims 36 and 37.

The invention is in addition based on the task of making available a beverage product on the basis of a method according to the invention.

According to the invention, this task is accomplished by means of a beverage product according to claim 38.

Advantageous and preferred exemplary embodiments of the methods according to the invention, the dip bath solution according to the invention, the liquid according to the invention, and the beverage product according to the invention will be described in the following. Figures are not needed for this, since the implementation of all the exemplary embodiments of the methods described in the following is easily evident to a person skilled in the art purely from the text, even without any representation in figures, in such detail that the person skilled in the art is already able, after studying the following text, to also carry out the exemplary embodiments of the methods, and since the compositions of all the exemplary embodiments described in the following, of the dip bath solution according to the invention and of the liquid according to the invention, are also easily evident to the person skilled in the art purely from the text, without any representation in figures, in such detail that the person skilled in the art is already able, solely after studying the following text, to himself/herself produce a mixture of these exemplary embodiments from the ingredients indicated, in each instance. The same holds true analogously for the beverage product according to the invention.

A first method according to the invention, for the production of a beverage for human consumption, which is filled into a container and contains at least one empirical piece of at least one flavor carrier, wherein the aforementioned flavor carrier consists of organic material and/or of material of an organic origin, has the following steps:

for at least 15 seconds, preferably for 3.5 minutes to 5.0 minutes, dipping the empirical flavor carrier piece or the empirical flavor carrier pieces into a dip bath solution consisting of water, ascorbic acid, a first remainder, and, if present, a second remainder, namely 74% to 98% water, 0.5% to 5% ascorbic acid, 0.5% to 2% first remainder, and 0% to 19% second remainder, wherein the percentage values indicated are mass percentage values, wherein the first remainder consists of calcium chloride and/or potassium chloride and/or calcium carbonate and/or potassium carbonate and/or calcium hydrogen carbonate and/or potassium hydrogen carbonate, and wherein the second remainder has oxygen and/or a vitamin other than ascorbic acid or multiple vitamins other than ascorbic acid and/or minerals and/or dietary fiber and/or secondary plant substances,

afterward, placing the empirical flavor carrier piece or the empirical flavor carrier pieces into the container, afterward, filling the container with a liquid having a temperature of at least 70° C., preferably at least 80° C., even more preferably at least 90° C., consisting of water, ascorbic acid, and, if present, the aforementioned second remainder, namely 70% to 98% water, 2% to 5% ascorbic acid, and 0% to 25% second remainder, wherein the percentage values indicated are mass percentage values, and afterward, closing the container.

A second method according to the invention, for the production of a beverage for human consumption, which is filled into a container and contains at least one empirical piece of at least one flavor carrier, wherein the aforementioned flavor carrier consists of organic material and/or of material of an organic origin, has the following steps:
for at least 15 seconds, preferably for 3.5 minutes to 5.0 minutes, dipping the empirical flavor carrier piece or the empirical flavor carrier pieces into a dip bath solution consisting of water, ascorbic acid, a first remainder, and, if present, a second remainder, namely 74% to 98% water, 0.5% to 5% ascorbic acid, 0.5% to 2% first remainder, and 0% to 19% second remainder, wherein the percentage values indicated are mass percentage values, wherein the first remainder consists of calcium chloride and/or potassium chloride and/or calcium carbonate and/or potassium carbonate and/or calcium hydrogen carbonate and/or potassium hydrogen carbonate, and wherein the second remainder has oxygen and/or a vitamin other than ascorbic acid or multiple vitamins other than ascorbic acid and/or minerals and/or dietary fiber and/or secondary plant substances,
afterward, placing the empirical flavor carrier piece or the empirical flavor carrier pieces into the container,
afterward, filling the container with a liquid consisting of water, ascorbic acid, and, if present, the aforementioned second remainder, namely 70% to 98% water, 2% to 5% ascorbic acid, and 0% to 25% second remainder, wherein the percentage values indicated are mass percentage values, and
afterward, closing the container and heating the closed container, along with its contents, to at least 70° C., preferably at least 80° C., even more preferably at least 90° C., for a time of at least 30 seconds, preferably for a time of at least 5 minutes.

A third method according to the invention, for the production of a beverage for human consumption, which is filled into a container and contains at least one empirical piece of at least one flavor carrier, wherein the aforementioned flavor carrier consists of organic material and/or of material of an organic origin, has the following steps:
for at least 15 seconds, preferably for 3.5 minutes to 5.0 minutes, dipping the empirical flavor carrier piece or the empirical flavor carrier pieces into a dip bath solution consisting of water, ascorbic acid, a first remainder, and, if present, a second remainder, namely 74% to 98% water, 0.5% to 5% ascorbic acid, 0.5% to 2% first remainder, and 0% to 19% second remainder, wherein the percentage values indicated are mass percentage values, wherein the first remainder consists of calcium chloride and/or potassium chloride and/or calcium carbonate and/or potassium carbonate and/or calcium hydrogen carbonate and/or potassium hydrogen carbonate, and wherein the second remainder has oxygen and/or a vitamin other than ascorbic acid or multiple vitamins other than ascorbic acid and/or minerals and/or dietary fiber and/or secondary plant substances,
afterward, placing the empirical flavor carrier piece or the empirical flavor carrier pieces into the container, into which, immediately before or simultaneously, a liquid having a temperature of at least 70° C., preferably at least 80° C., even more preferably at least 90° C., was or is filled, wherein the liquid consists of water, ascorbic acid, and, if present, the aforementioned second remainder, namely 70% to 98% water, 2% to 5% ascorbic acid, and 0% to 25% second remainder, wherein the percentage values indicated are mass percentage values, and
afterward, closing the container.

A fourth method according to the invention, for the production of a beverage for human consumption, which is filled into a container and contains at least one empirical piece of at least one flavor carrier, wherein the aforementioned flavor carrier consists of organic material and/or of material of an organic origin, has the following steps:
for at least 15 seconds, preferably for 3.5 minutes to 5.0 minutes, dipping the empirical flavor carrier piece or the empirical flavor carrier pieces into a dip bath solution consisting of water, ascorbic acid, a first remainder, and, if present, a second remainder, namely 74% to 98% water, 0.5% to 5% ascorbic acid, 0.5% to 2% first remainder, and 0% to 19% second remainder, wherein the percentage values indicated are mass percentage values, wherein the first remainder consists of calcium chloride and/or potassium chloride and/or calcium carbonate and/or potassium carbonate and/or calcium hydrogen carbonate and/or potassium hydrogen carbonate, and wherein the second remainder has oxygen and/or a vitamin other than ascorbic acid or multiple vitamins other than ascorbic acid and/or minerals and/or dietary fiber and/or secondary plant substances,
afterward, placing the empirical flavor carrier piece or the empirical flavor carrier pieces into the container, into which, before or simultaneously, a liquid was or is filled, wherein the liquid consists of water, ascorbic acid, and, if present, the aforementioned second remainder, namely 70% to 98% water, 2% to 5% ascorbic acid, and 0% to 25% second remainder, wherein the percentage values indicated are mass percentage values, and
afterward, closing the container and heating the closed container, along with its contents, to at least 70° C., preferably at least 80° C., even more preferably at least 90° C., for a time of at least 30 seconds, preferably for a time of at least 5 minutes.

A fifth method according to the invention, for the production of a beverage for human consumption, which is filled into a container and contains at least one empirical piece of at least one flavor carrier, wherein the aforementioned flavor carrier consists of organic material and/or of material of an organic origin, has the following steps:
for at least 15 seconds, preferably for 3.5 minutes to 5.0 minutes, dipping the empirical flavor carrier piece or the empirical flavor carrier pieces into a dip bath solution consisting of water, ascorbic acid, a first remainder, and, if present, a second remainder, namely 74% to 98% water, 0.5% to 5% ascorbic acid, 0.5% to 2% first remainder, and 0% to 19% second remainder, wherein the percentage values indicated are mass percentage values, wherein the first remainder consists of calcium chloride and/or potassium chloride and/or calcium carbonate and/or potassium carbonate and/or calcium hydrogen carbonate and/or potassium hydrogen carbonate, and wherein the second remainder has oxygen and/or a vitamin other than ascorbic acid or multiple vitamins other than ascorbic acid and/or minerals and/or dietary fiber and/or secondary plant substances,
afterward, placing the empirical flavor carrier piece or the empirical flavor carrier pieces into the container,
afterward, filling the container with a liquid consisting of water, ascorbic acid, and, if present, the aforementioned second remainder, namely 70% to 98% water, 2% to 5% ascorbic acid, and 0% to 25% second remainder, wherein the percentage values indicated are mass percentage values, and
afterward, closing the container, and
afterward, transporting the container into a high-pressure pasteurization apparatus, in which the container, along with its contents, is subjected to high-pressure pasteurization, using a pressure of at least 5000 bar, preferably at least 5500 bar.

A sixth method according to the invention, for the production of a beverage for human consumption, which is filled into a container and contains at least one empirical piece of at least one flavor carrier, wherein the aforementioned flavor carrier consists of organic material and/or of material of an organic origin, has the following steps:
for at least 15 seconds, preferably for 3.5 minutes to 5.0 minutes, dipping the empirical flavor carrier piece or the empirical flavor carrier pieces into a dip bath solution consisting of water, ascorbic acid, a first remainder, and, if present, a second remainder, namely 74% to 98% water, 0.5% to 5% ascorbic acid, 0.5% to 2% first remainder, and 0% to 19% second remainder, wherein the percentage values indicated are mass percentage values, wherein the first remainder consists of calcium chloride and/or potassium chloride and/or calcium carbonate and/or potassium carbonate and/or calcium hydrogen carbonate and/or potassium hydrogen carbonate, and wherein the second remainder has oxygen and/or a vitamin other than ascorbic acid or multiple vitamins other than ascorbic acid and/or minerals and/or dietary fiber and/or secondary plant substances,
afterward, placing the empirical flavor carrier piece or the empirical flavor carrier pieces into the container, into which, before or simultaneously, a liquid was or is filled, wherein the liquid consists of water, ascorbic acid, and, if present, the aforementioned second remainder, namely 70% to 98% water, 2% to 5% ascorbic acid, and 0% to 25% second remainder, wherein the percentage values indicated are mass percentage values, and
afterward, closing the container, and
afterward, transporting the container into a high-pressure pasteurization apparatus, in which the container, along with its contents, is subjected to high-pressure pasteurization, using a pressure of at least 5000 bar, preferably at least 5500 bar.

The method steps indicated above for the six methods according to the invention, in each instance, are the minimum method steps to be carried out, in each instance, for the corresponding method according to the invention. In this connection, in the case of some of the exemplary embodiments of the method according to the invention, the word “afterward,” which is used for the corresponding method description, can have the meaning of “subsequently” or “immediately subsequently,” but does not necessarily have to mean this. In particular, in the case of some of the further developments of the method, a further method step or even multiple further method steps, for example the addition of a specific powder and/or of a certain tablet, which is intended to be dissolved, can be inserted between method steps previously described, as will be described in greater detail below for some further developments of the method according to the invention, which are given as examples in this regard. Although it is preferred in every case—and also easily possible in the case of a method sequence that is set up to run fully automatically, for example—to carry out the individual method steps—no matter what embodiment or further development of the method according to the invention is involved—one after the other, if possible without any delay, a person skilled in the art will recognize that certain time tolerances, which can certainly be different in size in view of the individual method step sequence sections, are possible in a manner that is more practical for production practice and in this regard does not endanger the success of the method as a whole.

With regard to all the methods mentioned above, a further development of the method is preferred, in which the empirical flavor carrier or all the empirical flavor carriers used, in each instance, is/are washed with water before the corresponding flavor carrier piece is dipped in the aforementioned dip bath solution. Although such washing of the empirical flavor carrier or of the empirical flavor carriers before dipping the corresponding flavor carrier piece or the corresponding flavor carrier pieces into the aforementioned dip bath solution is very particularly preferred for hygiene reasons, and in practice all of the methods according to the invention, as explained above, are very predominantly carried out, in each instance, in the implementation form of the corresponding further development of the method that includes the step of washing all the empirical flavor carriers, in practice there are certainly occasionally also such implementation forms of the methods according to the invention in which such washing of individual ones, some or even all of the empirical flavor carriers used or of the empirical flavor carrier used is not necessary. This can be the case, for example, if a sage plant and/or a thyme plant, of which one leaf or leaves is/are used as an empirical flavor carrier piece or empirical flavor carrier pieces, was/were raised and harvested not as an outdoor plant or outdoor plants, but rather extensively shielded from environmental influences, without the use of pesticides and fungicides, and observing very high hygiene standards, in a building or in a tent.

Preferably, the aforementioned dip bath solution consists of 78% to 98% water, 0.5% to 5% ascorbic acid, 0.5% to 2% first remainder, and 0% to 15% second remainder, or of 83% to 98% water, 0.5% to 5% ascorbic acid, 0.5% to 2% first remainder, and 0% to 10% second remainder, or of 88% to 98% water, 0.5% to 5% ascorbic acid, 0.5% to 2% first remainder, and 0% to 5% second remainder, or of 95% to 98% water, 0.5% to 3% ascorbic acid, 0.5% to 2% first remainder, and 0% to 4% second remainder, wherein the percentage values indicated are mass percentage values. It is particularly preferred if the dip bath solution consists of 95% to 98% water, 0.5% to 3% ascorbic acid, 0.5% to 2% calcium chloride, wherein the percentage values indicated are mass percentage values. A dip bath solution consisting of 97% water, 2% ascorbic acid, and 1% calcium chloride, wherein the percentage values indicated are mass percentage values, is very particularly preferred.

Preferably the aforementioned liquid consists of 75% to 98% water, 2% to 5% ascorbic acid, and 0% to 20% second remainder, or of 80% to 98% water, 2% to 5% ascorbic acid, and 0% to 15% second remainder, or of 85% to 98% water, 2% to 5% ascorbic acid, and 0% to 10% second remainder, or of 90% to 98% water, 2% to 5% ascorbic acid, and 0% to 5% second remainder, or of 95% to 98% water, 2% to 5% ascorbic acid, and 0% to 3% second remainder, wherein the percentage values indicated are mass percentage values. It is particularly preferred if the liquid consists of 95% to 98% water, and 2% to 5% ascorbic acid, wherein the percentage values indicated are mass percentage values. A liquid consisting of 96% water and 4% ascorbic acid, wherein the percentage values indicated are mass percentage values, is very particularly preferred.

The vitamin or the vitamins and/or minerals and/or dietary fiber and/or secondary plant substances mentioned as a component or components of the second remainder can be derived, for example, from lemon and/or from any other citrus fruit and/or from acerola and/or from rosehip and/or from camu camu and/or from sea buckthorn and/or from kale and/or from any other kind of cabbage plant and/or from any other kind of vegetable and/or from any other kind of fruit.

Very generally, it holds true for all the methods according to the invention that in some exemplary embodiments of methods according to the invention, the second remainder is present neither in the aforementioned dip bath solution nor in the aforementioned liquid, that in the case of some other exemplary embodiments of methods according to the invention, the second remainder is present only in the aforementioned dip bath solution but not in the aforementioned liquid, that in the case of yet some other exemplary embodiments of methods according to the invention, the second remainder is present only in the aforementioned liquid but not in the aforementioned dip bath solution, and that if, in the case of once again other exemplary embodiments of methods according to the invention, the second remainder is present both in the aforementioned dip bath solution and in the aforementioned liquid, the concrete composition of the second remainder in the aforementioned dip bath solution does not necessarily have to be identical with the concrete composition of the second remainder in the aforementioned liquid, but again can be identical in the case of some other exemplary embodiments of methods according to the invention.

The empirical flavor carrier mentioned with reference to all the methods according to the invention as explained above can be or have, for example, a fruit and/or a berry and/or an herb and/or a leaf of a plant and/or a flower of a plant and/or a root of a plant and/or any component of a plant and/or activated charcoal and/or an insect and/or any component of an insect and/or a mushroom and/or any component of a mushroom.

If practical or if necessary in accordance with the circumstances of an individual case, it is preferred that the empirical flavor carrier or the empirical flavor carriers is/are peeled and/or deseeded and/or cut to size before being dipped in the dip bath solution.

If practical or if necessary in accordance with the circumstances of an individual case, it is very particularly preferred to use a further development of the method that includes the step of washing the empirical flavor carrier or the empirical flavor carriers, and furthermore to carry this step out in such a manner that the empirical flavor carrier or the empirical flavor carriers is/are peeled and/or deseeded and/or cut to size before washing and/or during washing and/or after washing, but before being dipped in the dip bath solution.

Various preferred implementation examples of the methods according to the invention are designed in such a manner that the empirical flavor carrier is or has at least one piece of a pineapple fruit or at least one piece of a lemon fruit or at least one cherry or at least one strawberry or at least one sage leaf or at least one piece of a thyme plant or at least one blackberry or at least one raspberry or at least one blueberry or at least one piece of lemongrass or at least one piece of a lime or at least one piece of mint or at least one piece of orange or at least one piece of turmeric or at least one piece of cardamom or at least one piece of date or at least one piece of rosemary or at least one hemp leaf or at least one piece of a hemp leaf or at least one piece of celery or at least one piece of apple or at least one piece of pear or at least one cacao nib or at least one coffee bean.

In the case of different preferred implementation examples of the methods according to the invention, at least two empirical pieces of the same kind are used as the empirical flavor carrier.

In the case of other implementation examples of the methods according to the invention, which are also preferred, at least two empirical pieces of different kinds are used as empirical flavor carriers. For example, one of the combinations listed below can be used:
pineapple and sage,
thyme and lemon,
blackberry and lemongrass,
lime, mint, and activated charcoal,
orange, turmeric, and cardamom,
date, rosemary, and activated charcoal,
celery, apple, and mint,
cacao nibs and coffee beans.

In this regard, the list of combinations presented in the preceding paragraph is merely a compilation of some few preferred combination examples. The methods according to the invention can easily be implemented also with many other combinations of empirical flavor carriers, wherein certainly even more than three empirical flavor carrier pieces, which can all be of different kinds, can be used at the same time.

In the case of further preferred implementation examples of any one of the methods according to the invention, a flavor-carrying and/or color-producing powder, for example a powder made of organic material or of material having an organic origin, is placed into the container as a first step in the method or at another time during implementation of the method, but at the latest immediately before closing the container. Turmeric powder and/or matcha powder and/or iron-containing powder and/or activated charcoal powder, for example, can be used as the aforementioned powder. For example, turmeric powder can advantageously be added if orange and/or cardamom is/are used as the empirical flavor carrier. In contrast to this, in the case of the combination of three, orange/turmeric/cardamom, which has already been mentioned above, an empirical piece, for example a piece of root, of the turmeric plant was used. The situation is similar for activated charcoal: as has already been mentioned above, activated charcoal can be used in piece form as an essentially non-dissolving empirical flavor carrier; however, activated charcoal can also be added simply in the form of activated charcoal powder, for example as an addition to the combination of the empirical flavor carriers lime and mint or, for example, as an addition to the combination of the empirical flavor carriers date and rosemary.

In the case of other, likewise preferred implementation examples of any one of the methods according to the invention, a flavor-carrying and/or color-producing substance in the form of a tablet, which is intended to be dissolved, is introduced into the container as a first step in the method or at another time during implementation of the method, but at the latest immediately before the container is closed. Preferably organic material or material of organic origin is used as the substance just mentioned. For example, the aforementioned tablet can be an activated-charcoal tablet intended to be dissolved, which is used together with the empirical flavor carrier or the empirical flavor carriers lime and/or mint and/or date and/or rosemary, wherein here the combinations lime and mint or date and rosemary are particularly preferred.

Preferably a bottle is used as the container that comes into use within the scope of the methods according to the invention as described above. However, the container can just as well be a container that is only similar to a bottle, or a can or a bucket or a beaker or a barrel or a vat or a pitcher or a pot or a container that is similar to a canning jar, or any other kind of vessel. Also, the volume, height, maximum and minimum width, as well as the shaping of the container are not subject to any kind of fundamental restrictions, within the scope of the methods according to the invention as described above. However, it is preferred to select such container sizes that are within the usual size range for beverage containers, beverage cans, and beverage bottles in the retail trade.

In the case of many preferred implementation examples of the methods according to the invention, a container that consists entirely or at least partially of plastic is used as the container, wherein here, preferably PET and very particularly preferably heat-resistant PET is used as the plastic. However, other plastics or combinations of plastics, for example combinations of PET with one or more other plastics, can also be used.

In the case of other implementation examples of the methods according to the invention, a container that consists of metal—for example in the form of a metal can—or a container that consists partially of plastic, for example PET, and partially of metal is used.

In the case of many other implementation examples, which are also preferred, of the first, second, third or fourth method according to the invention, a container that consists entirely or at least partially of glass, for example in the form of a glass bottle with a metal, plastic, ceramic and/or cork closure or, for example, in the form of a container similar to a canning jar, with a metal and/or glass closure on a rubber or plastic ring, is used as the container. In the case of yet other implementation examples of the first, second, third or fourth method according to the invention, a container that consists entirely or at least partially of ceramic material is used as the container.

Furthermore, in the case of other implementation examples of the methods according to the invention, a container that consists partially of plastic, for example PET, and partially of another material—for example of metal—can be used as the container.

Beyond this, in the case of once again other implementation examples of the methods according to the invention, a container that consists partially of metal and partially of another material—for example of plastic—can be used as the container.

For implementation of the first, second, third or fourth method according to the invention, it is, of course, necessary to select, as the container, a container that is structured in such a manner, from a materials technology point of view, that it withstands the temperatures or temperature jumps that occur during these methods without damage. For example, containers made of heat-resistant PET are well suited for this purpose.

For implementation of the fifth or sixth method according to the invention, it is, of course, necessary to use, as the container, a container that is structured in such a manner that it is suitable for carrying out high-pressure pasteurization. Preferably, in this connection one uses a container that consists of plastic, for example of PET, in which a side wall is configured in film-like manner, so thin that the container is suitable for carrying out the high-pressure pasteurization. However, a container that consists of metal, in which a side wall is configured in foil-like manner, so thin that the container is suitable for carrying out the high-pressure pasteurization, is also fundamentally suitable for implementation of the fifth or sixth method according to the invention, from purely technical aspects.

Although both those containers having a transparent wall and those containers having a wall that is only translucent or even completely non-transparent are suitable for use in the methods according to the invention, from purely technical aspects, containers having a transparent wall or having a wall surface that is kept transparent, at least to a great extent, are preferably used on the basis of pure marketing aspects. The reason for this is that consumers of what are called “Infused Waters” prefer, for esthetic reasons, to be able to view the beverage as a whole, i.e. with the empirical flavor carrier piece(s) contained in it, during the purchasing process, during storage or safekeeping—for example arranged decoratively as an eye-catcher—and during consumption, in its entirety.

A dip bath solution according to the invention, for use as the dip bath solution in a method according to the invention, consists of water, ascorbic acid, a first remainder and, if present, a second remainder, namely 74% to 98% water, 0.5% to 5% ascorbic acid, 0.5% to 2% first remainder, and 0% to 19% second remainder, wherein the percentage values indicated are mass percentage values, wherein the first remainder consists of calcium chloride and/or potassium chloride and/or calcium carbonate and/or potassium carbonate and/or calcium hydrogen carbonate and/or potassium hydrogen carbonate, and wherein the second remainder has oxygen and/or a vitamin other than ascorbic acid or multiple other vitamins other than ascorbic acid and/or minerals and/or dietary fiber and/or secondary plant substances.

Preferably, the aforementioned dip bath solution consists of 78% to 98% water, 0.5% to 5% ascorbic acid, 0.5% to 2% first remainder, and 0% to 15% second remainder, or of 83% to 98% water, 0.5% to 5% ascorbic acid, 0.5% to 2% first remainder, and 0% to 10% second remainder, or of 88% to 98% water, 0.5% to 5% ascorbic acid, 0.5% to 2% first remainder, and 0% to 5% second remainder, or of 95% to 98% water, 0.5% to 3% ascorbic acid, 0.5% to 2% first remainder, and 0% to 4% second remainder, wherein the percentage values indicated are mass percentage values. It is particularly preferred if the dip bath solution consists of 95% to 98% water, 0.5% to 3% ascorbic acid, and 0.5% to 2% calcium chloride, wherein the percentage values indicated are mass percentage values. A dip bath solution consisting of 97% water, 2% ascorbic acid, and 1% calcium chloride, wherein the percentage values indicated are mass percentage values, is very particularly preferred.

A liquid according to the invention, for use as the liquid in one of the methods according to the invention, consists of water, ascorbic acid, and, if present, a second remainder, namely 70% to 98% water, 2% to 5% ascorbic acid, and 0% to 25% second remainder, wherein the percentage values indicated are mass percentage values, and wherein the second remainder has oxygen and/or a vitamin other than ascorbic acid or multiple vitamins other than ascorbic acid and/or minerals and/or dietary fiber and/or secondary plant substances.

Preferably the aforementioned liquid consists of 75% to 98% water, 2% to 5% ascorbic acid, and 0% to 20% second remainder, or of 80% to 98% water, 2% to 5% ascorbic acid, and 0% to 15% second remainder, or of 85% to 98% water, 2% to 5% ascorbic acid, and 0% to 10% second remainder, or of 90% to 98% water, 2% to 5% ascorbic acid, and 0% to 5% second remainder, or of 95% to 98% water, 2% to 5% ascorbic acid, and 0% to 3% second remainder, wherein the percentage values indicated are mass percentage values. It is particularly preferred if the liquid consists of 95% to 98% water, and 2% to 5% ascorbic acid, wherein the percentage values indicated are mass percentage values. A liquid consisting of 96% water and 4% ascorbic acid, wherein the percentage values indicated are mass percentage values, is very particularly preferred.

The vitamin or vitamins and/or minerals and/or dietary fiber and/or secondary plant substances mentioned as a component or components of the second remainder, with reference to the dip bath solution according to the invention or with reference to the liquid according to the invention, can be derived, for example, from lemon and/or from any other citrus fruit and/or from acerola and/or from rosehip and/or from camu camu and/or from sea buckthorn and/or from kale and/or from any other kind of cabbage plant and/or from any other kind of vegetable and/or from any other kind of fruit.

Once again it should be emphasized, at this point, what has already been explained with regard to the dip bath solution and the liquid in connection with the methods according to the invention: It holds true, very generally, for all the methods according to the invention, that the second remainder is present neither in the aforementioned dip bath solution nor in the aforementioned liquid in the case of some exemplary embodiments of methods according to the invention, that the second remainder is present only in the aforementioned dip bath solution but not in the aforementioned liquid in the case of some other exemplary embodiments of methods according to the invention, that the second remainder is present only in the aforementioned liquid but not in the aforementioned dip bath solution in the case of yet other exemplary embodiments of methods according to the invention, and that if the second remainder is present both in the aforementioned dip bath solution and in the aforementioned liquid in the case of once again other exemplary embodiments of methods according to the invention, the concrete composition of the second remainder in the aforementioned dip bath solution does not necessarily have to be identical with the concrete composition of the second remainder in the aforementioned liquid, but certainly can be identical in the case of some exemplary embodiments of methods according to the invention.

A beverage product according to the invention has a beverage for human consumption that is produced by means of one of the methods according to the invention, is filled into a container, and contains at least one empirical piece of at least one flavor carrier. Consequently a container, along with the aforementioned contents, should be viewed as being a beverage product according to the invention. With regard to the preferred exemplary embodiments for containers in this regard, reference is explicitly made at this point to the special explanations already given in this regard above, in connection with the description of different exemplary embodiments of methods according to the invention.

1. A method for the production of a beverage for human consumption, which is filled into a container and contains at least one empirical piece of at least one flavor carrier, wherein the aforementioned flavor carrier comprises organic material and/or of material of an organic origin, and the method has the following steps:
for at least 15 seconds, preferably for 3.5 minutes to 5.0 minutes, dipping the empirical flavor carrier piece or the empirical flavor carrier pieces into a dip bath solution consisting of comprising water, ascorbic acid, a first remainder, and, if present, a second remainder, namely 74% to 98% water, 0.5% to 5% ascorbic acid, 0.5% to 2% first remainder, and 0% to 19% second remainder, wherein the percentage values indicated are mass percentage values, wherein the first remainder consists of comprises calcium chloride and/or potassium chloride and/or calcium carbonate and/or potassium carbonate and/or calcium hydrogen carbonate and/or potassium hydrogen carbonate, and wherein the second remainder has oxygen and/or a vitamin other than ascorbic acid or multiple vitamins other than ascorbic acid and/or minerals and/or dietary fiber and/or secondary plant substances,
afterward, placing the empirical flavor carrier piece or the empirical flavor carrier pieces into the container,
afterward, filling the container with a liquid having a temperature of at least 70° C., preferably at least 80° C., even more preferably at least 90 ° C., consisting of comprising water, ascorbic acid, and, if present, the aforementioned second remainder, namely 70% to 98% water, 2% to 5% ascorbic acid, and 0% to 25% second remainder, wherein the percentage values indicated are mass percentage values, and
afterward, closing the container.

2. A method for the production of a beverage for human consumption, which is filled into a container and contains at least one empirical piece of at least one flavor carrier, wherein the aforementioned flavor carrier comprises organic material and/or of material of an organic origin, and the method has the following steps:
for at least 15 seconds, preferably for 3.5 minutes to 5.0 minutes, dipping the empirical flavor carrier piece or the empirical flavor carrier pieces into a dip bath solution comprising water, ascorbic acid, a first remainder, and, if present, a second remainder, namely 74% to 98% water, 0.5% to 5% ascorbic acid, 0.5% to 2% first remainder, and 0% to 19% second remainder, wherein the percentage values indicated are mass percentage values, wherein the first remainder comprises calcium chloride and/or potassium chloride and/or calcium carbonate and/or potassium carbonate and/or calcium hydrogen carbonate and/or potassium hydrogen carbonate, and wherein the second remainder has oxygen and/or a vitamin other than ascorbic acid or multiple vitamins other than ascorbic acid and/or minerals and/or dietary fiber and/or secondary plant substances,
afterward, placing the empirical flavor carrier piece or the empirical flavor carrier pieces into the container,
afterward, filling the container with a liquid comprising water, ascorbic acid, and, if present, the aforementioned second remainder, namely 70% to 98% water, 2% to 5% ascorbic acid, and 0% to 25% second remainder, wherein the percentage values indicated are mass percentage values, and
afterward, closing the container and heating the closed container, along with its contents, to at least 70° C., preferably at least 80° C., even more preferably at least 90° C., for a time of at least 30 seconds, preferably for a time of at least 5 minutes.

3. A method for the production of a beverage for human consumption, which is filled into a container and contains at least one empirical piece of at least one flavor carrier, wherein the aforementioned flavor carrier comprises organic material and/or of material of an organic origin, and the method has the following steps:
for at least 15 seconds, preferably for 3.5 minutes to 5.0 minutes, dipping the empirical flavor carrier piece or the empirical flavor carrier pieces into a dip bath solution comprising water, ascorbic acid, a first remainder, and, if present, a second remainder, namely 74% to 98% water, 0.5% to 5% ascorbic acid, 0.5% to 2% first remainder, and 0% to 19% second remainder, wherein the percentage values indicated are mass percentage values, wherein the first remainder comprises calcium chloride and/or potassium chloride and/or calcium carbonate and/or potassium carbonate and/or calcium hydrogen carbonate and/or potassium hydrogen carbonate, and wherein the second remainder has oxygen and/or a vitamin other than ascorbic acid or multiple vitamins other than ascorbic acid and/or minerals and/or dietary fiber and/or secondary plant substances,
afterward, placing the empirical flavor carrier piece or the empirical flavor carrier pieces into the container, into which, immediately before or simultaneously, a liquid having a temperature of at least 70° C., preferably at least 80° C., even more preferably at least 90° C., was or is filled, wherein the liquid comprises water, ascorbic acid, and, if present, the aforementioned second remainder, namely 70% to 98% water, 2% to 5% ascorbic acid, and 0% to 25% second remainder, wherein the percentage values indicated are mass percentage values, and
afterward, closing the container.

4. A method for the production of a beverage for human consumption, which is filled into a container and contains at least one empirical piece of at least one flavor carrier, wherein the aforementioned flavor carrier comprises organic material and/or of material of an organic origin, and the method has the following steps:
for at least 15 seconds, preferably for 3.5 minutes to 5.0 minutes, dipping the empirical flavor carrier piece or the empirical flavor carrier pieces into a dip bath solution comprising water, ascorbic acid, a first remainder, and, if present, a second remainder, namely 74% to 98% water, 0.5% to 5% ascorbic acid, 0.5% to 2% first remainder, and 0% to 19% second remainder, wherein the percentage values indicated are mass percentage values, wherein the first remainder comprises calcium chloride and/or potassium chloride and/or calcium carbonate and/or potassium carbonate and/or calcium hydrogen carbonate and/or potassium hydrogen carbonate, and wherein the second remainder has oxygen and/or a vitamin other than ascorbic acid or multiple vitamins other than ascorbic acid and/or minerals and/or dietary fiber and/or secondary plant substances,
afterward, placing the empirical flavor carrier piece or the empirical flavor carrier pieces into the container, into which, before or simultaneously, a liquid was or is filled, wherein the liquid comprises water, ascorbic acid, and, if present, the aforementioned second remainder, namely 70% to 98% water, 2% to 5% ascorbic acid, and 0% to 25% second remainder, wherein the percentage values indicated are mass percentage values, and
afterward, closing the container and heating the closed container, along with its contents, to at least 70° C., preferably at least 80° C., even more preferably at least 90° C., for a time of at least 30 seconds, preferably for a time of at least 5 minutes.

5. A method for the production of a beverage for human consumption, which is filled into a container and contains at least one empirical piece of at least one flavor carrier, wherein the aforementioned flavor carrier comprises organic material and/or of material of an organic origin, and the method has the following steps:
for at least 15 seconds, preferably for 3.5 minutes to 5.0 minutes, dipping the empirical flavor carrier piece or the empirical flavor carrier pieces into a dip bath solution consisting of comprising water, ascorbic acid, a first remainder, and, if present, a second remainder, namely 74% to 98% water, 0.5% to 5% ascorbic acid, 0.5% to 2% first remainder, and 0% to 19% second remainder, wherein the percentage values indicated are mass percentage values, wherein the first remainder comprises calcium chloride and/or potassium chloride and/or calcium carbonate and/or potassium carbonate and/or calcium hydrogen carbonate and/or potassium hydrogen carbonate, and wherein the second remainder has oxygen and/or a vitamin other than ascorbic acid or multiple vitamins other than ascorbic acid and/or minerals and/or dietary fiber and/or secondary plant substances,
afterward, placing the empirical flavor carrier piece or the empirical flavor carrier pieces into the container,
afterward, filling the container with a liquid comprising water, ascorbic acid, and, if present, the aforementioned second remainder, namely 70% to 98% water, 2% to 5% ascorbic acid, and 0% to 25% second remainder, wherein the percentage values indicated are mass percentage values, and
afterward, closing the container, and
afterward, transporting the container into a high-pressure pasteurization apparatus, in which the container, along with its contents, is subjected to high-pressure pasteurization, using a pressure of at least 5000 bar, preferably at least 5500 bar.

6. A method for the production of a beverage for human consumption, which is filled into a container and contains at least one empirical piece of at least one flavor carrier, wherein the aforementioned flavor carrier comprises organic material and/or material of an organic origin, and the method has the following steps:
for at least 15 seconds, preferably for 3.5 minutes to 5.0 minutes, dipping the empirical flavor carrier piece or the empirical flavor carrier pieces into a dip bath solution comprising water, ascorbic acid, a first remainder, and, if present, a second remainder, namely 74% to 98% water, 0.5% to 5% ascorbic acid, 0.5% to 2% first remainder, and 0% to 19% second remainder, wherein the percentage values indicated are mass percentage values, wherein the first remainder comprises calcium chloride and/or potassium chloride and/or calcium carbonate and/or potassium carbonate and/or calcium hydrogen carbonate and/or potassium hydrogen carbonate, and wherein the second remainder has oxygen and/or a vitamin other than ascorbic acid or multiple vitamins other than ascorbic acid and/or minerals and/or dietary fiber and/or secondary plant substances,
afterward, placing the empirical flavor carrier piece or the empirical flavor carrier pieces into the container, into which, before or simultaneously, a liquid was or is filled, wherein the liquid comprises water, ascorbic acid, and, if present, the aforementioned second remainder, namely 70% to 98% water, 2% to 5% ascorbic acid, and 0% to 25% second remainder, wherein the percentage values indicated are mass percentage values, and
afterward, closing the container, and
afterward, transporting the container into a high-pressure pasteurization apparatus, in which the container, along with its contents, is subjected to high-pressure pasteurization, using a pressure of at least 5000 bar, preferably at least 5500 bar.

7. The method according to claim 1, wherein if precisely one empirical flavor carrier is used, it is washed with water before being dipped in the aforementioned dip bath solution, or if multiple empirical flavor carriers are used, one, some or all of these empirical flavor carriers is/are washed with water before being dipped in the aforementioned dip bath solution.

8. The method according to claim 1, wherein the empirical flavor carrier mentioned is or has a fruit and/or a berry and/or an herb and/or a leaf of a plant and/or a flower of a plant and/or a root of a plant and/or any component of a plant and/or activated charcoal and/or an insect and/or any component of an insect and/or a mushroom and/or any component of a mushroom.

9. The method according to claim 1, wherein the empirical flavor carrier or the empirical flavor carriers is/are peeled and/or deseeded and/or cut to size before being dipped in the dip bath solution.

10. The method according to claim 9, wherein the empirical flavor carrier or the empirical flavor carriers is/are peeled and/or deseeded and/or cut to size before washing and/or during washing and/or after washing.

11. The method according to claim 1, wherein the empirical flavor carrier is or has at least one piece of a pineapple fruit or at least one piece of a lemon fruit or at least one cherry or at least one strawberry or at least one sage leaf or at least one piece of a thyme plant or at least one blackberry or at least one raspberry or at least one blueberry or at least one piece of lemongrass or at least one piece of a lime or at least one piece of mint or at least one piece of orange or at least one piece of turmeric or at least one piece of cardamom or at least one piece of date or at least one piece of rosemary or at least one hemp leaf or at least one piece of a hemp leaf or at least one piece of celery or at least one piece of apple or at least one piece of pear or at least one cacao nib or at least one coffee bean.

12. The method claim 1, wherein at least two empirical pieces of the same kind are used as the empirical flavor carrier.

13. The method according to claim 1, wherein at least two empirical pieces of different kinds are used as empirical flavor carriers.

14. The method according to claim 13, wherein one of the combinations listed below is used:
pineapple and sage,
thyme and lemon,
blackberry and lemongrass,
lime, mint, and activated charcoal,
orange, turmeric, and cardamom,
date, rosemary, and activated charcoal,
celery, apple, and mint,
cacao nibs and coffee beans.

15. The method according to claim 1, wherein a flavor-carrying and/or color-producing powder is placed into the container as a first step in the method or at another time during implementation of the method, but at the latest immediately before closing the container.

16. The method according to claim 15, wherein the aforementioned powder is or has organic material or material having an organic origin.

17. The method according to claim 15, wherein the aforementioned powder is turmeric powder and/or matcha powder and/or iron-containing powder and/or activated charcoal powder.

18. The method according to claim 17, wherein
turmeric powder is used as the aforementioned powder, and orange and/or cardamom is/are used as the empirical flavor carrier(s), or
activated charcoal powder is used as the aforementioned powder and lime and/or mint is/are used as the empirical flavor carrier(s), or
activated charcoal powder is used as the aforementioned powder and date and/or rosemary is/are used as the empirical flavor carrier(s).

19. The method according to claim 1, wherein a flavor-carrying and/or color-producing substance in the form of a tablet, which is intended to be dissolved, is introduced into the container as a first step in the method or at another time during implementation of the method, but at the latest immediately before the container is closed.

20. The method according to claim 19, wherein the aforementioned substance is or has organic material or material of an organic origin.

21. The method according to claim 19, wherein the aforementioned tablet is an activated charcoal tablet.

22. The method according to claim 21, wherein lime and/or mint and/or date and/or rosemary is/are used as the empirical flavor carrier(s).

23. The method according to claim 1, wherein the container is a bottle or a beaker or a can or a bucket or a barrel or a vat or a pitcher or a pot.

24. The method according to claim 1, wherein the container consists entirely or is made at least partially of plastic and/or of metal.

25. The method according to claim 24, wherein the container consists entirely or is made at least partially of PET.

26. The method according to claim 25, wherein the container consists entirely or is made at least partially of heat-resistant PET.

27. The method according to claim 24, wherein a side wall of the container is configured in film-like manner, so thin that the container is suitable for carrying out the high-pressure pasteurization.

28. The method according to claim 1, wherein the container consists entirely or is made at least partially of glass and/or ceramic material.

29. The method according to claim 1, wherein the dip bath solution consists of comprises 78% to 98% water, 0.5% to 5% ascorbic acid, 0.5% to 2% first remainder, and 0% to 15% second remainder, or 83% to 98% water, 0.5% to 5% ascorbic acid, 0.5% to 2% first remainder, and 0% to 10% second remainder, or 88% to 98% water, 0.5% to 5% ascorbic acid, 0.5% to 2% first remainder, and 0% to 5% second remainder, or 95% to 98% water, 0.5% to 3% ascorbic acid, 0.5% to 2% first remainder, and 0% to 4% second remainder, or 97% water, 2% ascorbic acid, and 1% calcium chloride, wherein the percentage values indicated are mass percentage values.

30. The method according to claim 1, wherein the liquid comprises 75% to 98% water, 2% to 5% ascorbic acid, and 0% to 20% second remainder, or 80% to 98% water, 2% to 5% ascorbic acid, and 0% to 15% second remainder, or 85% to 98% water, 2% to 5% ascorbic acid, and 0% to 10% second remainder, or 90% to 98% water, 2% to 5% ascorbic acid, and 0% to 5% second remainder, or 95% to 98% water, 2% to 5% ascorbic acid, and 0% to 3% second remainder, or 96% water and 4% ascorbic acid, wherein the percentage values indicated are mass percentage values.

31. The method according to claim 1, wherein the vitamin or vitamins and/or minerals and/or dietary fiber and/or secondary plant substances mentioned as a component or components of the second remainder is/are derived from lemon and/or from any other citrus fruit and/or from acerola and/or from rosehip and/or from camu camu and/or from sea buckthorn and/or from kale and/or from any other kind of cabbage plant and/or from any other kind of vegetable and/or from any other kind of fruit.

32. A dip bath solution for use as the dip bath solution in the method according to claim 1, wherein the dip bath solution comprises water, ascorbic acid, a first remainder and, if present, a second remainder, namely 74% to 98% water, 0.5% to 5% ascorbic acid, 0.5% to 2% first remainder, and 0% to 19% second remainder, wherein the percentage values indicated are mass percentage values, wherein the first remainder comprises calcium chloride and/or potassium chloride and/or calcium carbonate and/or potassium carbonate and/or calcium hydrogen carbonate and/or potassium hydrogen carbonate, and wherein the second remainder has oxygen and/or a vitamin other than ascorbic acid or multiple vitamins other than ascorbic acid and/or minerals and/or dietary fiber and/or secondary plant substances.

33. The dip bath solution according to claim 32, wherein the dip bath solution comprises 78% to 98% water, 0.5% to 5% ascorbic acid, 0.5% to 2% first remainder, and 0% to 15% second remainder, or 83% to 98% water, 0.5% to 5% ascorbic acid, 0.5% to 2% first remainder, and 0% to 10% second remainder, or 88% to 98% water, 0.5% to 5% ascorbic acid, 0.5% to 2% first remainder, and 0% to 5% second remainder, or 95% to 98% water, 0.5% to 3% ascorbic acid, 0.5% to 2% first remainder, and 0% to 4% second remainder, or 97% water, 2% ascorbic acid, and 1% calcium chloride, wherein the percentage values indicated are mass percentage values.

34. The dip bath solution according to claim 32, wherein the vitamin or vitamins and/or minerals and/or dietary fiber and/or secondary plant substances mentioned as a component or components of the second remainder is/are derived from lemon and/or from any other citrus fruit and/or from acerola and/or from rosehip and/or from camu camu and/or from sea buckthorn and/or from kale and/or from any other kind of cabbage plant and/or from any other kind of vegetable and/or from any other kind of fruit.

35. A liquid for use as the liquid in the method according to claim 1, wherein the liquid comprises water, ascorbic acid, and, if present, a second remainder, namely 70% to 98% water, 2% to 5% ascorbic acid, and 0% to 25% second remainder, wherein the percentage values indicated are mass percentage values, and wherein the second remainder has oxygen and/or a vitamin other than ascorbic acid or multiple vitamins other than ascorbic acid and/or minerals and/or dietary fiber and/or secondary plant substances.

36. The liquid according to claim 35, wherein the liquid comprises 75% to 98% water, 2% to 5% ascorbic acid, and 0% to 20% second remainder, or 80% to 98% water, 2% to 5% ascorbic acid, and 0% to 15% second remainder, or 85% to 98% water, 2% to 5% ascorbic acid, and 0% to 10% second remainder, or 90% to 98% water, 2% to 5% ascorbic acid, and 0% to 5% second remainder, or 95% to 98% water, 2% to 5% ascorbic acid, and 0% to 3% second remainder, or 96% water and 4% ascorbic acid, wherein the percentage values indicated are mass percentage values.

37. The liquid according to claim 35, wherein the vitamin or vitamins and/or minerals and/or dietary fiber and/or secondary plant substances mentioned as a component or components of the second remainder is/are derived from lemon and/or from any other citrus fruit and/or from acerola and/or from rosehip and/or from camu camu and/or from sea buckthorn and/or from kale and/or from any other kind of cabbage plant and/or from any other kind of vegetable and/or from any other kind of fruit.

38. A beverage product, having a beverage for human consumption, produced by means of the method according to claim 1, filled into a container and containing at least one empirical piece of at least one flavor carrier.
